(19) United States
(12) Patent Application Publication
(10) Pub. No.: US 2013/0138674 A1
(43) Pub. Date: May 30, 2013

(54) SYSTEM AND METHOD FOR RECOMMENDING APPLICATION BY USING KEYWORD

(71) Applicants: Jin-guk JEONG, Yongin-si (KR); Min-ho LEE, Gwacheon-si (KR); Hyun-chul CHOI, Suwon-si (KR)

(72) Inventors: Jin-guk JEONG, Yongin-si (KR); Min-ho LEE, Gwacheon-si (KR); Hyun-chul CHOI, Suwon-si (KR)

(73) Assignee: SAMSUNG ELECTRONICS CO., LTD., Suwon-si (KR)

(21) Appl. No.: 13/615,184

(22) Filed: Sep. 13, 2012

(30) Foreign Application Priority Data
Nov. 30, 2011 (KR) 10-2011-0127258

(51) Int. Cl. G06F 17/30

(52) U.S. Cl. 707/758; 707/E17.005

(57) ABSTRACT

A system and method for recommending an application by using a keyword. A keyword-based application recommending user terminal includes a keyword extraction unit for extracting a keyword from an application that is running, a recommended application determination unit for determining an application to be recommended to correspond to the extracted keyword and a display unit for displaying the determined application.

### CROSS-REFERENCE TO RELATED APPLICATION(S) AND CLAIM OF PRIORITY

The present application is related to and claims the benefit of Korean Patent Application No. 10-2011-0127258, filed on Nov. 30, 2011, in the Korean Intellectual Property Office, the disclosure of which is incorporated herein in its entirety by reference.

### TECHNICAL FIELD OF THE INVENTION

The present disclosure relates to a system and method for recommending an application by using a keyword, and more particularly, to a system and method for recommending another application by using a keyword extracted from an application in a user terminal.

### BACKGROUND OF THE INVENTION

It is possible to install and use many applications in devices, such as a smart phone, a mobile phone, a personal digital assistant (PDA), a personal computer (PC), and a television (TV). Such a device can directly access a server via any of various networks and can access the server according to any of various methods by using various browsing programs.

However, conventionally, it is not easy to select and use a lot of applications installed in a device and it is difficult to effectively provide a user with a recommended application related to an application that is running.

### SUMMARY OF THE INVENTION

To address the above-discussed deficiencies of the prior art, it is a primary object to provide a keyword-based application recommending system and method capable of displaying a recommended application corresponding to a keyword included in an application that is running.

Another aspect of the present disclosure provides a keyword-based application recommending system and method capable of recommending an application that is highly related to a keyword associated with a keyword included in an application that is running.

Another aspect of the present disclosure provides a keyword-based application recommending system and method capable of effectively running a recommended application corresponding to a keyword included in an application that is running and inputting the keyword to the recommended application.

According to another aspect of the present disclosure, there is provided a user terminal for recommending an application by using a keyword, which includes a keyword extraction unit for extracting a keyword from an application that is running, a recommended application determination unit for determining an application to be recommended to correspond to the extracted keyword and a display unit for displaying the determined application.

The user terminal can further include a keyword providing unit for providing the extracted keyword to a server. The recommended application determination unit can determine the recommended application from a list of applications recommended based on the keyword, which is received from the server.

The list of recommended applications can be determined by the server, based on correlations between the keyword and applications.

The list of recommended applications can be determined by the server, based on correlations between at least one from among the keyword and keywords associated with the keyword and applications.

The correlations can be determined by the server, based on a category of the keyword.

The correlations can be determined by the server, based on a hyperlink corresponding to the keyword.

The keyword extraction unit can extract a keyword input to the application that is running.

The keyword extraction unit can extract a keyword from a text displayed when the application is run.

If a keyword displayed when the application is run is selected, the display unit can display a list of recommended applications corresponding to the selected keyword, on a screen thereof.

If a recommended application is selected from the list of recommended applications, the selected recommended application can be run.

If the selected recommended application is run, the selected keyword can be input to the recommended application.

The user terminal can further include a keyword providing unit for providing the extracted keyword to the server. The recommended application determination unit can determine the recommended application, based on keywords associated with the provided keyword, which are received from the server.

The recommended application determination unit can determine the recommended application, based on correlations between the associated keywords and applications installed in the user terminal.

According to another aspect of the present disclosure, there is provided a server for recommending an application by using a keyword, which includes a keyword receiving unit for receiving a keyword from a user terminal, a recommended application determination unit for determining applications to be recommended, according to the received keyword, and an application recommending unit for providing a list of recommended applications to the user terminal. The received keyword is extracted from an application that is running in the user terminal.

The recommended application determination unit can determine the recommended application, based on correlations between the received keyword and applications.

The recommended application determination unit can obtain the correlations, based on hyperlink information corresponding to the received keyword.

The server can further include an associated keyword collection unit for collecting keywords associated with the received keyword. The recommended application determination unit can determine the recommended application, based on the collected associated keywords.

The recommended application determination unit can determine the recommended application, based on correlations between at least one from among the received keyword and the collected associated keywords and applications.

An application that is installed in the user terminal from among the recommended applications listed in the list of recommended applications provided to the user terminal can be recommended as the recommended application to the user terminal.

The received keyword can be extracted based on a text input by using the application that is running in the user terminal.

The received keyword can be extracted from a text included in the application that is running in the user terminal.

According to another aspect of the present disclosure, there is provided a server for providing associated keywords for recommending an application, which includes a keyword receiving unit for receiving a keyword from a user terminal, an associated keyword generation unit for collecting keywords associated with the received keyword, and an associated keyword providing unit for providing the collected associated keywords to the user terminal. The received keyword is extracted from an application that is running in the user terminal, and the provided associated keywords are used for the user terminal to recommend an application.

According to another aspect of the present disclosure, there is provided a method of recommending an application by using a keyword, which includes extracting a keyword from an application that is running that is running in a user terminal, determining an application to be recommended to correspond to the extracted keyword, and displaying the recommended application.

According to another aspect of the present disclosure, there is provided a method of recommending an application to a user terminal by using a keyword, which includes receiving a keyword from the user terminal, determining applications to be recommended, based on the received keyword and providing a list of the determined recommended applications to the user terminal. The received keyword is extracted from an application that is running in the user terminal.

According to another aspect of the present disclosure, there is provided a method of providing a user terminal with associated keywords for recommending an application, which includes receiving a keyword from the user terminal, collecting keywords associated with the received keyword and providing the collected associated keywords to the user terminal. The received keyword is extracted from an application that is running in the user terminal, and the associated keywords are used for the user terminal to recommend an application.

According to another aspect of the present disclosure, there is provided a computer readable recording medium having recorded thereon a computer program for executing the method of recommending an application by using a keyword.

According to another aspect of the present disclosure, there is provided a computer readable recording medium having recorded thereon a computer program for executing the method of recommending an application to a user terminal by using a keyword.

According to another aspect of the present disclosure, there is provided a computer readable recording medium having recorded thereon a computer program for executing the method of providing a user terminal with an associated keyword for recommending an application.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a structure of a keyword-based application recommending system according to an embodiment of the present disclosure;

FIG. 2 illustrates a user terminal according to anther embodiment of the present disclosure;

FIG. 3 illustrates a server according to another embodiment of the present disclosure;

FIG. 4 illustrates a structure of a keyword-based application recommending system according to another embodiment of the present disclosure;

FIG. 5 is illustrates a server according to another embodiment of the present disclosure;

FIG. 6 is illustrates a user terminal according to another embodiment of the present disclosure;

FIG. 7 illustrates a keyword information table according to another embodiment of the present disclosure;

FIG. 8 illustrates an application information table according to another embodiment of the present disclosure;

FIG. 9 illustrates a exemplary screen image displaying a list of recommended application corresponding to a keyword extracted from an application that is running, according to another embodiment of the present disclosure;

FIG. 10 illustrates another exemplary screen image for the process of selecting and running an application to recommend, according to another embodiment of the present disclosure;

FIG. 11 illustrates a keyword-based application recommending method according to another embodiment of the present disclosure; and

FIG. 12 illustrates flowchart showing a keyword-based application recommending method according to another embodiment of the present disclosure.

### DETAILED DESCRIPTION OF THE INVENTION

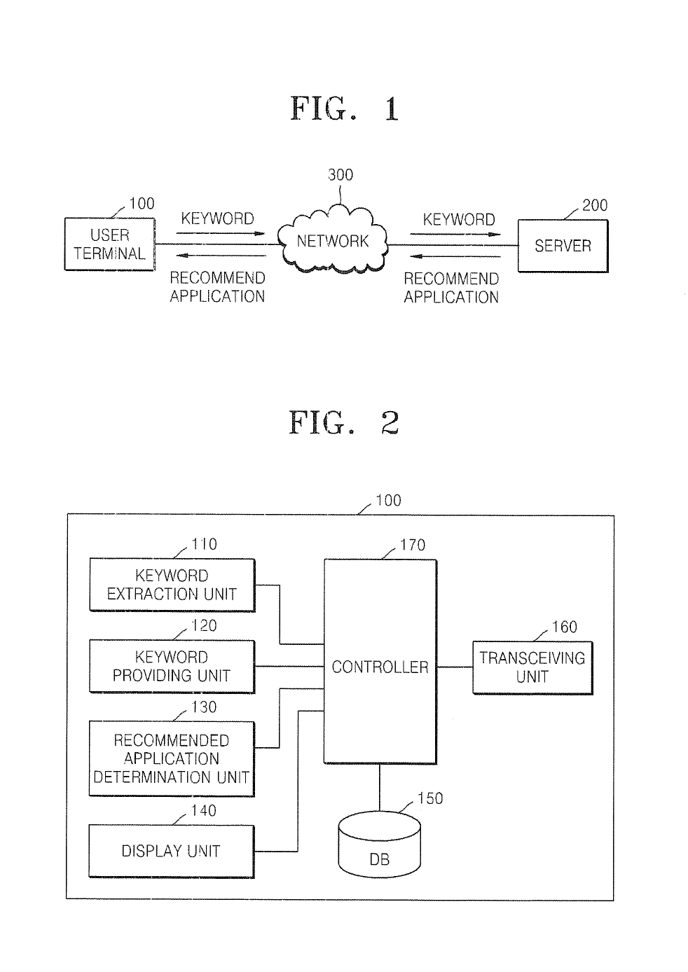

FIGS. 1 through 12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged. Hereinafter, exemplary embodiments of the present disclosure will be described more fully with reference to the accompanying drawings. This disclosure can, however, be embodied in many different forms and should not be construed as being limited to the embodiments set forth herein. Rather, these embodiments are provided so that this disclosure will be thorough and complete and will fully convey the concept of the disclosure to those of ordinary skill in the art. In the drawings, well-known functions or constructions are not described in detail if it is determined that they would obscure the disclosure due to unnecessary detail, and the same reference numerals represent the same elements throughout the drawings.

It will be understood that when an element or layer is referred to as being ‘connected to’ another element or layer, the element or layer can be directly connected to another element or be electrically connected to another element via other device. It will be further understood that when an element or layer includes another element or layer, the element or layer can further include one or more other elements, unless specified otherwise.

As used herein, expressions such as “at least one of,” when preceding a list of elements, modify the entire list of elements and do not modify the individual elements of the list.

FIG. 1 illustrates a structure of a keyword-based application recommending system according to an embodiment of the present disclosure. The keyword-based application recommending system includes the user terminal 100, the server 200, and the network 300.

The user terminal 100 is connected to the server 200 via the network 300, provides the server 200 with at least one keyword extracted from an application that is running in the user terminal 100. The server 200 recommends at least one application selected based on the at least one of keywords. The user terminal 100 can be any suitable types of the terminal capable of running an application, e.g., a mobile phone, a smart phone, a personal digital assistant (PDA), a notebook computer, or a smart television (TV). Examples of the user terminal 100 may include various types of terminals to be connected to the server 200 via the network 300.

The server 200 determines at least one application to be recommended by using the at least one keyword, and provides the user terminal 100 with information about the at least one determined application. The server 200 can collect keywords associated with the keywords received from the user terminal 100, and calculate correlations between the associated keywords and the applications, based on the category of the keyword. Then, the server 200 can recommend at least one application to the user terminal 100, based on the calculated correlations.

The user terminal 100 can display a recommended application related to the keyword contained in the application that is running in the user terminal 100, on a screen thereof, and can easily execute the recommended application with a user's input.

The network 300 is an inclusive concept of data communication network that allows the user terminal 100 and the server 200 to communicate with each other. Examples of the network 300 include a wired Internet, a wireless Internet, and a mobile wireless communication network. In certain embodiments, the network 300 can be an exclusive line, a local area network (LAN), a value-added network (VAN), an intra net, a private telephone network, a public telephone network, a public switched telephone network (PSTN), or a combination thereof.

FIG. 2 illustrates a user terminal according to an embodiment of the present disclosure. The user terminal 100 includes a keyword extraction unit 110, a keyword providing unit 120, a recommended application determination unit 130, a display unit 140, a database (DB) 150, a transceiving unit 160, and a controller 170.

The keyword extraction unit 110 extracts a keyword from an application that is running in the user terminal 100. The keyword extraction unit 110 can extract a keyword from a text contained in an application that is running in the user terminal 100. The keyword extraction unit 110 can parse the text and extract a keyword from the parsed text. In this embodiment, the keyword extraction unit 110 can determine type of the parsed text and extracts a noun contained in the parsed text as a keyword.

If a keyword is input to an active application, the keyword extraction unit 110 can extract the input keyword from the application. For example, when a user inputs a company name into an stock related application, the keyword extraction unit 110 can extract the input company name as a keyword.

The keyword providing unit 120 provides information about an extracted keyword to the server 200. The keyword providing unit 120 can provide the server 200 with the extracted keyword, a text containing the extracted keyword, and information about the application from which the keyword is extracted. If a company name ‘A’ is extracted from a web page of an application, the keyword providing unit 120 can provide the server 200 with the company name ‘A’, information about the web page from which the company name ‘A’ is extracted, and the name of the application.

The recommended application determination unit 130 determines at lease one application to be displayed on the display unit 140 from among applications recommended from the server 200. The recommended application determination unit 130 can receive a list of recommended applications from the server 200, and select at least on application to be displayed on the display unit 140 from the list of recommended applications.

In certain embodiments, the server 200 can recommend applications to the user terminal 100, based on the received keyword.

Also, the recommended application determination unit 130 can mark recommended applications that are running or being downloaded. In this embodiment, the recommended application determination unit 130 can determine applications to be installed in the user terminal 100 from the list of the recommended applications, as recommended applications that can be run. In certain embodiments, the recommended application determination unit 130 can determine applications not to be installed in the user terminal 100 from the list of recommended applications, as recommended applications that can be downloaded.

The display unit 140 displays a recommended application on a screen thereof. When a keyword is selected from an active application, the display unit 140 can display a recommended application corresponding to the selected keyword on the screen thereof. For example, the display unit 140 can display a list of recommended applications corresponding to the selected keyword on the screen. In certain embodiments, the display unit 140 can display a recommended application corresponding to the selected keyword on the screen, for example, by using a popup window. In certain embodiments, the display unit 140 can display a recommended application by using a hyperlink.

If one of recommended applications displayed on the screen is selected according to a user's input, the selected recommended application starts to run. Also, a keyword corresponding to a recommended application can be input to the recommended application when the recommended application is running.

If a recommended application displayed on the screen, which is not installed in the user terminal 100, is selected according to a user's input, the selected recommended application can be downloaded using link information corresponding thereto.

The DB 150 stores various information based on which the user terminal 100 can select and display a recommended application according to the keyword extracted from an application that runs in the user terminal 100. The DB 150 can further store information about recommended applications corresponding to keywords.

The transceiving unit 160 exchanges various information such as what the user terminal 100 determines and displays according to a keyword extracted from an application that runs in the user terminal 100, with the server 200.

The controller 170 controls overall operations of the user terminal 100, and controls the keyword extraction unit 110, the keyword providing unit 120, the recommended application determination unit 130, the display unit 140, the DB 150, and the transceiving unit 160 so that the user terminal 100 can determine, display, and run a recommended application based on a keyword extracted from an application that runs in the user terminal 100

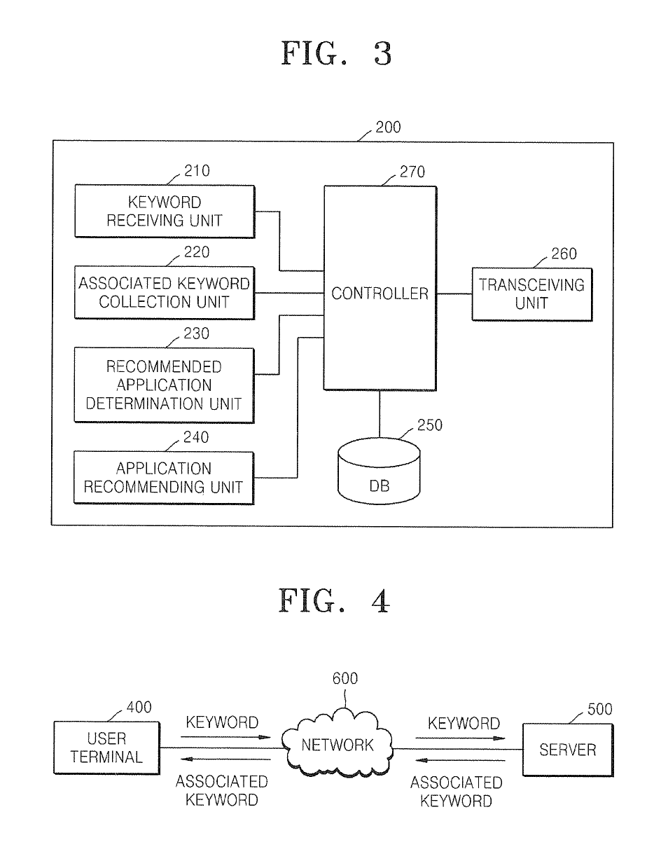

FIG. 3 illustrates a server according to another embodiment of the present disclosure. The server 200 includes a keyword receiving unit 210, an associated keyword collection unit 220, a recommended application determination unit 230, an application recommending unit 240, a DB 250, a transceiving unit 260, and a controller 270.

The keyword receiving unit 210 receives a keyword from the user terminal 100 of FIG. 1. The keyword receiving unit 210 can receive a keyword included in an application that runs in the user terminal 100. Otherwise, the keyword receiving unit 210 can receive information about an extracted keyword from the user terminal 100. Otherwise, the keyword receiving unit 210 can receive a keyword, a text containing the keyword, and information about the application from which the keyword is extracted, from the user terminal 100. For example, if a keyword ‘Park Ji-Sung’ is extracted from a web page of an application, the keyword receiving unit 210 can receive the keyword ‘Park Ji-Sung’, information about the web page, and the name of the application.

The associated keyword collection unit 220 collects keywords associated with a received keyword. The associated keyword collection unit 220 can collect associated keywords based on a text containing the received keyword and lexical information about the keyword. Also, the associated keyword collection unit 220 can collect a plurality of associated keywords for each of the received keywords.

More specifically, the associated keyword collection unit 220 can determine meaning of a received keyword based on the lexical information of the keyword, and collect keywords associated with the keyword based on the determined meaning. Also, the associated keyword collection unit 220 can collect keywords associated with the received keyword by checking meaning of words related to the received keyword in the text containing the received keyword. Also, if the received keyword is a homonym, then the associated keyword collection unit 220 can determine the meaning of the received keyword, based on a text including the received keyword, which is received from the user terminal 100, and then collects keywords associated with the received keyword. For example, a word ‘hero’ can be understood as the title of a song or as defined by the dictionary. In this case, the associated keyword collection unit 220 can determine the meaning of the word ‘hero’ by checking words related to the word ‘hero’ in a text including the word ‘hero’, and then collects keywords associated with the word ‘hero’, based on a result of the determining.

Furthermore, the associated keyword collection unit 220 can check a category of a keyword, based on a text including the keyword, which is received from the user terminal 100, and then collect keywords associated with the keyword. For example, if the associated keyword collection unit 220 receives a keyword ‘Park Ji-Sung’ and information on a web page containing the keyword ‘Park Ji-Sung’ from the user terminal 100, then the associated keyword collection unit 220 can check hyperlink information corresponding to the keyword ‘Park Ji-Sung’ at this web page and determine that the category of the keyword ‘Park Ji-Sung’ is ‘news’ and ‘soccer’ based on the hyperlink information. Also, the associated keyword collection unit 220 can collect keywords, e.g., ‘Manchester’, ‘Premier League’, and ‘assist’, which are associated with the keyword ‘Park Ji-Sung’, based on the category ‘soccer’.

The recommended application determination unit 230 determines at least one application to be recommended corresponding to the received keyword. In certain embodiments, the recommended application determination unit 230 determines an application to be recommended corresponding to the received keyword based on keywords associated with the received keyword.

The recommended application determination unit 230 can determine an application to be recommended in units of keywords by comparing meta data of the applications with associated keywords. The meta data of the applications include information related to the applications, e.g., the names and categories of the applications, a number of times of downloading each of the applications, and types of devices that can run each of the applications. Such meta data can have been collected and stored in the server 200 in units of applications.

More specifically, the recommended application determination unit 230 can compare meta data of the applications with associated keywords to calculate the correlations between each of the applications and the associated keywords. The recommended application determination unit 230 can determine a recommended application for a received keyword, based on the calculated correlations. In this case, the recommended application determination unit 230 can determine an application whose sum of the correlations is equal to or greater than a predetermined threshold, as the application to be recommended.

For example, if a keyword ‘Park Ji-Sung’ is received from the user terminal 100, categories of the keyword ‘Park Ji-Sung’ are ‘news’ and ‘soccer’, and keywords associated with the keyword ‘Park Ji-Sung’ are ‘Manchester’, ‘Premier League’, and ‘assist’, then the recommended application determination unit 230 can determine an application to be recommended for the keyword ‘Park Ji-Sung’ by calculating correlations between each of applications and the associated keywords and adding the correlations together. In this case, the categories ‘news’ and ‘soccer’ can be used to select applications that are targets of the correlation calculation. In other words, the recommended application determination unit 230 can compare applications related to the categories ‘news’ and ‘soccer’ with the associated keywords so as to calculate correlations between each of applications and the associated keywords. Here, an application that provides news about Manchester United can have a highest correlation.

However, in certain embodiments, a keyword category, associated keywords, and meta data about applications can be used to calculate such a correlation, according to various algorithms.

The application recommending unit 240 provides a determined recommended application to the user terminal 100. The application recommending unit 240 can generate a list of recommended applications and provide the list of recommended applications to the user terminal 100. In this case, the list of recommended applications can include link information for downloading these applications.

The DB 250 stores various information necessary to determine an application to be recommended corresponding to a received keyword and recommend the application to the user terminal 100. The DB 250 can store information, e.g., keyword category and associated keywords of each received keyword. Also, the DB 250 can store meta data of the applications.

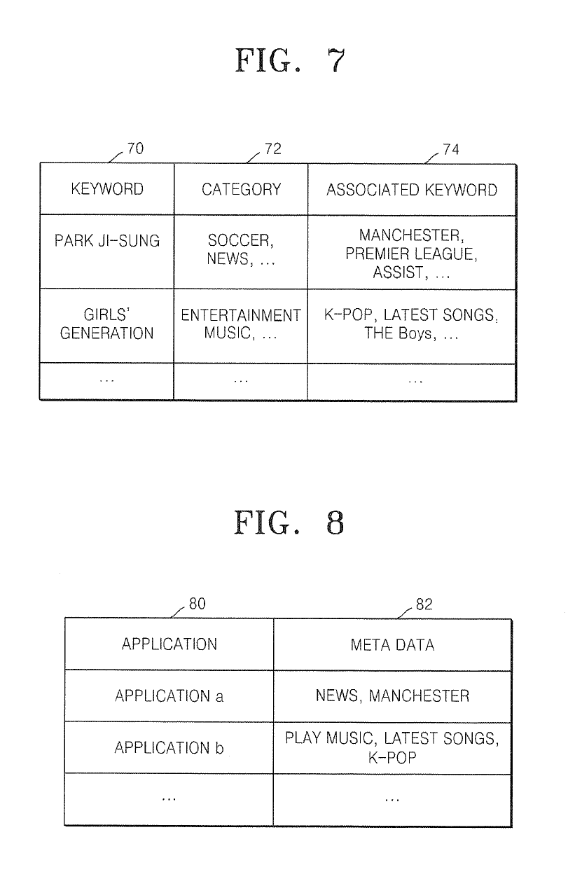

Examples of a keyword information table and an application information table that can be stored in the DB 250 will be described in detail with reference to FIGS. 7 and 8 below.

The transceiving unit 260 transmits or receives various information needed to determine an application to be recommended to correspond to a received keyword and recommend the application to the user terminal 100.

The controller 270 controls overall operations of the server 200, and controls the keyword receiving unit 210, the associated keyword collection unit 220, the recommended application determination unit 230, the application recommending unit 240, the DB 250, and the transceiving unit 260 so that server 200 can determine an application corresponding to a received keyword an recommend the application to the user terminal 100.

FIG. 4 illustrates a structure of a keyword-based application recommending system according to another embodiment of the present disclosure. The keyword-based application recommending system 200 includes a user terminal 400, a server 500, and a network 600.

The user terminal 400 can be connected to the server 500 via the network 600 and provide a keyword to the server 500. The server 500 can collect keywords associated with the keyword.

Then, the user terminal 400 can receive the associated keywords from the server 500, determine an application to be recommended, based on the associated keywords, and display the determined application on a display thereof. The user terminal 400 can calculate correlations between the associated keywords and each of the applications, and determine an application to be recommended, based on the correlations.

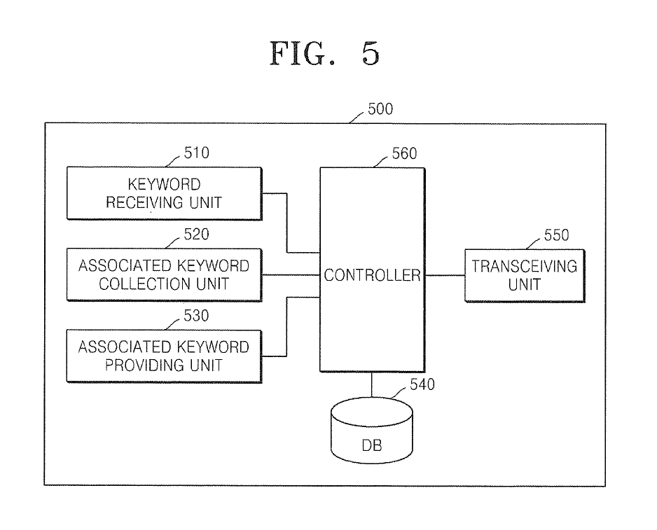

FIG. 5 is a diagram of a server 500 according to another embodiment of the present disclosure. The server 500 includes a keyword receiving unit 510, an associated keyword collection unit 520, an associated keyword providing unit 530, a DB 540, a transceiving unit 550, and a controller 560.

The keyword receiving unit 510 receives a keyword from the user terminal. The keyword receiving unit 510 can receive a keyword included in an application that runs in the user terminal 400. Also, the keyword receiving unit 510 can receive information about an extracted keyword from the user terminal 400. The keyword receiving unit 510 can receive a keyword, a text containing the keyword, and information about an application from which the keyword is extracted, from the user terminal 400.

The associated keyword collection unit 520 collects keywords associated with a received keyword. The associated keyword collection unit 520 can collect associated keywords by using a text including the received keyword and lexical information about the keyword. Also, the associated keyword collection unit 520 can collect a plurality of associated keywords for each of received keywords.

In certain embodiments, the associated keyword collection unit 520 can check lexical information about a keyword received from the user terminal 400, and collect keywords associated with the keyword, based on the lexical information. In this case, the associated keyword collection unit 520 can extract associated keywords included in the lexical information, based on the meaning of the received keyword.

If a received keyword is a homonym, the associated keyword collection unit 520 can determine the meaning of the keyword, based on a text including the keyword, which is received from the user terminal 400, and then extract keywords associated with the keyword.

Also, the associated keyword collection unit 520 can determine the category of a keyword, based on a text containing the keyword, which is received from the user terminal 400, and collect keywords associated with the keyword based on the determined category.

The associated keyword providing unit 530 provides the collected associated keywords to the user terminal 400. The provided associated keywords can be used for the user terminal to determine a recommended application corresponding to an extracted keyword.

The DB 540 stores various information for collecting keywords associated with a received keyword. The DB 540 can store information regarding each of received keywords, e.g., a category and associated keywords thereof.

The transceiving unit 550 transmits and receives various information for collecting keywords associated with a received keyword.

The controller 560 controls overall operations of the server 500, and controls the keyword receiving unit 510, the associated keyword collection unit 520, the associated keyword providing unit 530, the DB 540, and the transceiving unit 550 so that the server 500 can collect keywords associated with a received keyword and provide the associated keywords to the user terminal 400.

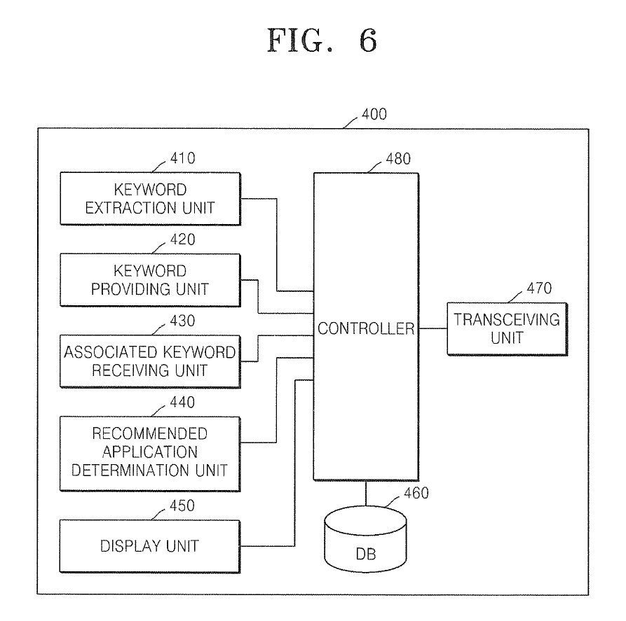

FIG. 6 illustrates a user terminal according to another embodiment of the present disclosure. The user terminal 400 includes a keyword extraction unit 410, a keyword providing unit 420, an associated keyword receiving unit 430, a recommended application determination unit 440, a display unit 450, a DB 460, a transceiving unit 470, and a controller 480.

Operations of the keyword extraction unit 410, the keyword providing unit 420, the display unit 450, the DB 460, the transceiving unit 470, and the controller 480 of FIG. 6 are the same as those of the keyword extraction unit 110, the keyword providing unit 120, the display unit 140, the DB 150, the transceiving unit 160, and the controller 170 included in the user terminal 100 of FIG. 2, and are incorporated into this embodiment.

The associated keyword receiving unit 430 receives associated keywords from the server 500 of FIG. 4. The associated keywords can be used for the recommended application determination unit 440 to determine a recommended application corresponding to an extracted keyword.

The recommended application determination unit 440 determines a recommended application corresponding to the extracted keyword by using the associated keywords.

The recommended application determination unit 440 can determine a recommended application for each of keywords by comparing meta data of the applications with associated keywords. The meta data of the applications are information related to the applications, e.g., the names and categories of the applications, a number of times of downloading each of the applications, and types of devices that can run each of the applications. Such meta data can have been collected and stored in units of applications installed in the user terminal 400.

In certain embodiments, the recommended application determination unit 440 can compare meta data of the applications with associated keywords to calculate correlations between the associated keywords and the applications. Also, a recommended application for an extracted keyword can be determined based on correlations calculated in units of keywords associated with the extracted keyword. In this case, the recommended application determination unit 230 can determine an application whose sum of the correlations is equal to or greater than a predetermined threshold, as a recommended application.

In certain embodiments, the recommended application determination unit 440 can calculate a correlation between an associated keyword and an application installed in the user terminal 400.

FIG. 7 illustrates a exemplary keyword information table according to another embodiment of the present disclosure. The keyword information table includes a keyword field 70, a category field 72, and an associated keyword field 74.

In the keyword field 70, a keyword extracted in the user terminal 100 of FIG. 1 are recorded. A keyword can be extracted from a text displayed when an application runs in the user terminal 100 or a keyword input to the running application can be extracted, and then be provided to the server 200 of FIG. 1. The extracted keyword can be recorded in the keyword fields 70. For example, ‘Park Ji-Sung’ and ‘Girls' Generation’ can be recorded in the keyword fields 70.

In the category fields 72, categories corresponding to an extracted keyword are recorded. The server 200 can check a category of a keyword, based on a text that contains the keywords, which is received from the user terminal 100, and record the checked category to the category fields 72. For example, when the server 200 receives a keyword ‘Park Ji-Sung’ and information about a web page including the keyword ‘Park Ji-Sung’ from the user terminal 100, the server 200 can check hyperlinked information corresponding to ‘Park Ji-Sung’ at the web page, and determine that the categories of the keyword ‘Park Ji-Sung’ are ‘news’ and ‘soccer’, based on the hyperlinked information.

In the associated keyword field 74, collected keywords associated with the keywords are recorded. The server 200 can collect and record associated keywords, e.g., ‘Manchester’, ‘Premier League’, and ‘assist’, based on that the keyword is ‘Park Ji-Sung’ and the category thereof is ‘soccer’.

FIG. 8 illustrates an application information table according to an embodiment of the present disclosure. The application information table includes application fields 80 and meta data fields 82.

The name of an application is recorded in the application fields 80, and meta data of the application is recorded in the meta data fields 82. The meta data is information related to the corresponding application, e.g., the name and category of the corresponding application, a number of times of downloading the corresponding application, and types of device applications that can run the corresponding application. Such meta data can be stored in the server 200 of FIG. 1 in units of applications. The recorded meta data can be compared with at least one from among keywords, the categories of the keywords, and keywords associated with the keywords to determine an application to be recommended in units of the keywords.

For example, if an application ‘a’ is related to news provided from Manchester United, then meta data, e.g., ‘news’ and ‘Manchester’, can be collected and stored in relation to the application ‘a’.

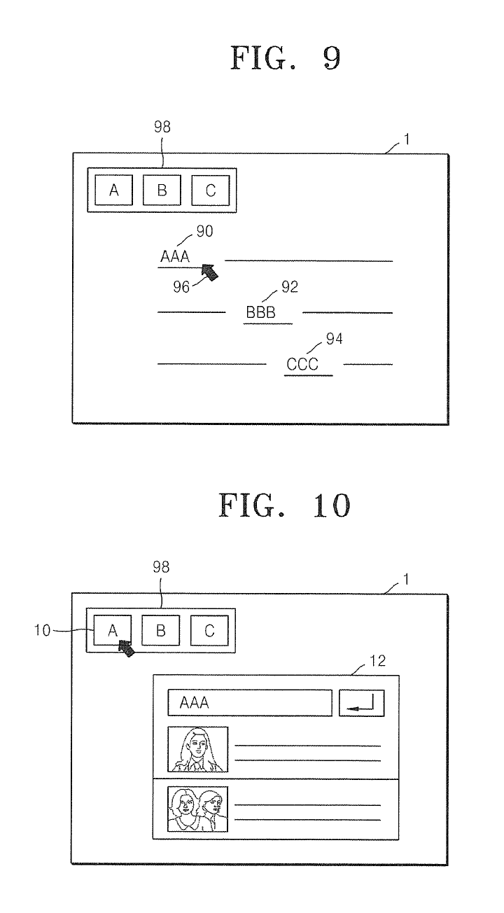

FIG. 9 illustrates the exemplary screen image displaying the recommended applications corresponding to a keyword extracted from an active application, according to another embodiment of the present disclosure. The screen image 1 can be displayed on the display of user terminal 100. A text contained in the screen image 1 can include a keyword ‘AAA’ 90, a keyword ‘BBB’ 92, and a keyword ‘CCC’ 94. Also, a list of recommended applications related to the keyword ‘AAA’ 90, the keyword ‘BBB’ 92, and the keyword ‘CCC’ 94 can be provided. In certain embodiments, the keyword ‘AAA’ 90, the keyword ‘BBB’ 92, and the keyword ‘CCC’ 94, the list of recommended applications of which can be underlined.

If the keyword ‘AAA’ 90 is selected according to a user input, as pointed by an arrow 96, a list 98 of recommended application related to the keyword ‘AAA’ 90 can be displayed in the screen image 1.

Thus, a user can efficiently check information about an application related to a keyword contained in an application during use of the application on the user terminal 100.

FIG. 10 illustrates the screen image for showing a process of selecting and running a recommended application, according to another embodiment of the present disclosure.

When an application ‘A’ 10 is selected from a list 98 of recommended applications displayed in a screen image 1, according to a user's input, a screen image 12 produced when the application ‘A’ 10 can start to run in the form of a popup window.

If the application ‘A’ 10 is run, a keyword ‘AAA’ can be input to the application ‘A’ 10 and a result of inputting the keyword ‘AAA’ to the application ‘A’ 10 can be displayed.

Accordingly, a user can efficiently run the related application linked to the keyword contained in the application that is running in the user terminal 100, and easily input another input value to the application that is running.

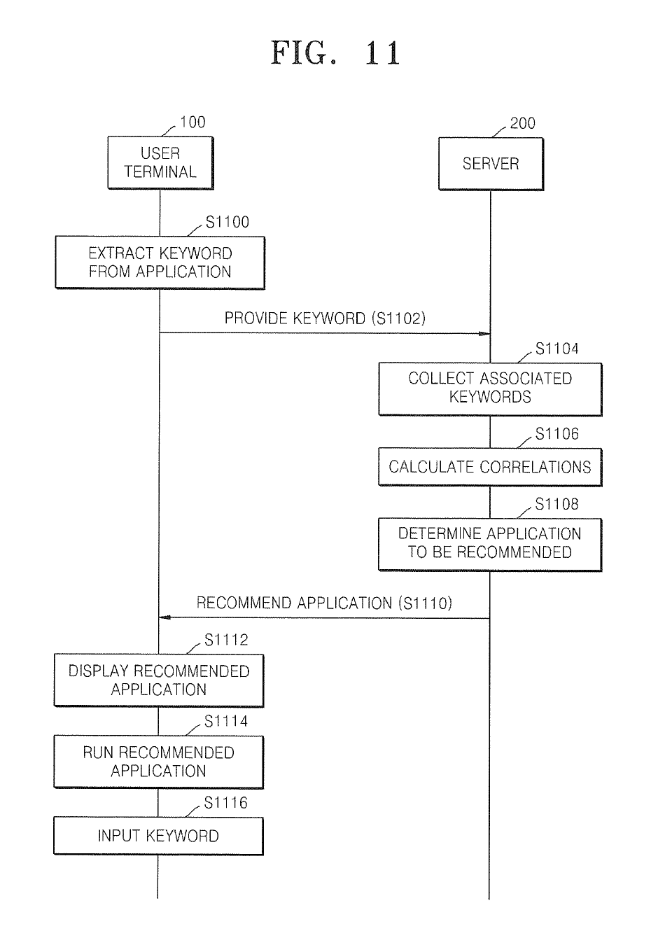

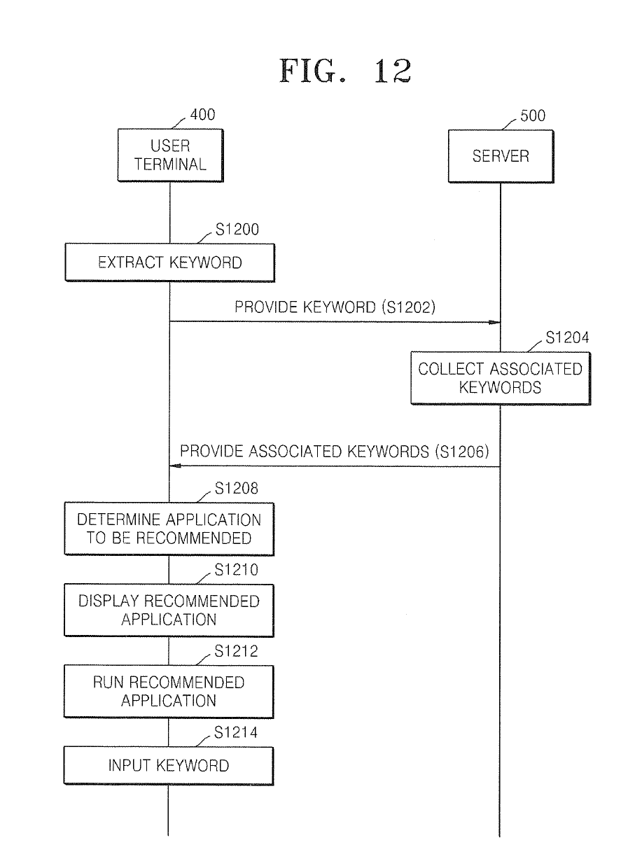

FIG. 11 illustrates a flowchart showing a keyword-based application recommending method according to another embodiment of the present disclosure.

In operation S1100, the user terminal 100 of FIG. 1 extracts a keyword from an application that is running therein. In operation S1100, the user terminal 100 can extract a keyword from a text included in this application. In certain embodiments, the user terminal 100 can parse the text and extract a keyword from the text. In this case, the user terminal 100 can check a type of the parsed text and extract a noun from the parsed text as a keyword.

Also, in operation S1100, if a keyword has been input to the active application, the user terminal 100 can extract the input keyword from the application. For example, if a company name is input to an application related to stocks, the user terminal 100 can extract the input company name as a keyword.

Then, in operation S1102, the user terminal 100 provides the extracted keyword to the server 200 of FIG. 1. In operation S1102, the user terminal 100 can provide the server 200 with the extracted keyword, a text containing the keyword, and information regarding the application from which the keyword is extracted. For example, if a keyword ‘Park Ji-Sung’ is extracted from a web page of an application, the user terminal 100 can provide the server 200 with the keyword ‘Park Ji-Sung’, information on the web page from which keyword ‘Park Ji-Sung’ is extracted, and the name of the application.

Then, in operation S1104, the server 200 collects keywords associated with the keyword received from the user terminal 100. In operation S1104, the server 200 can collect associated keywords, based on a text containing the received keyword and lexical information about the received keyword. Also, the server 200 can collect a plurality of keywords for each of a plurality of received keywords. In certain embodiments, the server 200 can check the lexical information about the received keyword, and extract keywords associated with the received keyword, based on the lexical information. In this case, the server 200 can extract associated keywords included in the lexical information, based on the meaning of the received keyword.

In operation S1104, if the received keyword is a homonym, the server 200 can determine the meaning of the received keyword, based on a text including the received keyword, which is received from the user terminal 100, and then extract keywords associated with the received keyword. For example, a word ‘hero’ can be understood as the title of a song or as defined by the dictionary. In this case, the server 200 can determine the meaning of the word ‘hero’ by checking words related to the word ‘hero’ in a text containing the word ‘hero’. Also, the server 200 can collect keywords associated with the word ‘hero’, based on the determined meaning.

Also, in operation S1104, the server 200 can determine a category of the received keyword, based on a text containing the received keyword, which is received from the user terminal 100, and collect keywords associated with the received keyword according to the category. For example, if the server 200 receives a keyword ‘Park Ji-Sung’ and information about a web page including the keyword ‘Park Ji-Sung’ from the user terminal 100, the server 200 can check hyperlinked information corresponding to the keyword ‘Park Ji-Sung’ at this web page and determine that the category of the keyword ‘Park Ji-Sung’ is ‘news’ and ‘soccer’, based on the hyperlinked information. Also, the server 200 can collect ‘Manchester’, ‘Premier League’, and ‘assist’ as keywords associated with the keyword ‘Park Ji-Sung’, based on the category ‘soccer’.

Then, in operation S1106, the server 200 calculates correlations between the associated keywords and applications. In operation S1106, the server 200 can calculate correlations between the associated keywords and applications by using meta data of each application. Here, the meta data about each of the applications is information about the application, e.g., the name and category of the application, a number of times of downloading the application, and types of devices that can run the application. Such meta data can be collected and stored in the server 200 according to each application.

For example, if the server 200 receives a keyword ‘Park Ji-Sung’ from the user terminal 100, the category of the keyword ‘Park Ji-Sung’ is ‘news’ and ‘soccer’, and keywords associated with the keyword ‘Park Ji-Sung’ are ‘Manchester’, ‘Premier League’, and ‘assist’, then the server 200 can calculate correlations between the associated keywords ‘Manchester’, ‘Premier League’, and ‘assist’ and applications. In this case, a correlation between an application that provides news about Manchester United and the keyword ‘Park Ji-sung’ can be highest.

Then, in operation S1108, the server 200 determines applications to be recommended according to the received keyword. In operation S1108, the server 200 can determine applications to be recommended according to the received keyword, based on the correlations calculated in operation S1106. Then, the server 200 can check the corresponding recommended applications, and determine applications whose sum of the correlations is equal to or greater than a predetermined threshold, as recommended applications.

Then, in operation S1110, the server 200 recommends the determined applications to the user terminal 100. In operation 81110, the server 200 can provide the user terminal 100 with a list of recommended applications. The list of recommended applications can include the names of the recommended applications and link information for downloading the recommended applications.

Then, in operation S1112, the user terminal 100 displays the recommended applications. In operation S1112, if a keyword is selected from the application that is running in the user terminal 100, the user terminal 100 can display a recommended application corresponding to the selected keyword, on a screen thereof. The user terminal 100 can display an icon of the corresponding recommended application on the screen. Also, the user terminal 100 can display the corresponding recommended application in the form of a popup window on the screen. Also, the user terminal 100 can display the corresponding recommended application on the screen by using a hyperlink.

The user terminal 100 can display the recommended applications in such a manner that recommended applications that are runing or being downloaded can be differentiated from one another. The user terminal 100 may display applications that have been installed therein from the list of recommended applications. In certain embodiments, the user terminal 100 can display applications that have not been installed therein from the list of recommended applications, while recommended applications are being downloaded.

Then, in operation S1114, the user terminal 100 runs one of the recommended applications. In operation S1114, when one of the displayed recommended applications is selected according to a user's input, the user terminal 100 can run the selected recommended application. If the selected recommended application is not installed in the user terminal 100, the user terminal 100 can download the selected recommended application by using linked information corresponding to the selected recommended application.

Then, in operation S1116, the user inputs a keyword to the active recommended application. In operation S1116, the user terminal 100 can input a selected keyword to the recommended application so as to display the recommended application when the recommended application is running.

FIG. 12 illustrates a keyword-based application recommending method according to another embodiment of the present disclosure.

In operation S1200, the user terminal 400 of FIG. 6 extracts a keyword from an active application. In operation S1200, the user terminal 400 can extract a keyword from a text contained in an active application.

Also, in operation S1200, if a keyword is input to the active application, the user terminal 400 can extract a keyword from the application.

Then, in operation S1202, the user terminal 400 provides the extracted keyword to the server 500 of FIG. 5. In operation S1202, the user terminal 400 can provide the server 500 with the extracted keyword, a text containing the extracted keyword, and information about the application from which the keyword is extracted.

Then, in operation S1204, the server 500 collects keywords associated with the keyword received from the user terminal 400. In operation S1204, the server 500 can collect associated keywords, based on a text containing the received keyword and lexical information about the received keyword. Also, the server 500 can collect a plurality of associated keywords for each of received keywords. In certain embodiments, the server 500 can check the lexical information about the received keyword, and extract keywords associated with the received keyword from the lexical information. In this case, the server 500 can extract associated keywords from the lexical information based on the meaning of the received keyword.

Also, in operation S1204, if the received keyword is a homonym, the server 500 can determine the meaning of the received keyword, based on a text containing the received keyword, which is received from the user terminal 400, and then extract keywords associated with the received keyword.

Also, in operation S1204, the server 500 can check a category of the received keyword, based on a text containing the received keyword, which is received from the user terminal 400, and then extract keywords associated with the received keyword according to the category.

Then, in operation S1206, the server 500 provides the associated keywords to the user terminal 400.

Then, in operation S1208, the user terminal 400 determines an application to be recommended. In operation S1208, the user terminal 400 can determine an application to be recommended corresponding to the extracted keyword, based on the associated keywords.

In operation S1208, the user terminal 400 can compare meta of each application with the associated keywords to determine an application to be recommended according to each keyword. Such meta data can have been collected and stored according to each application installed in the user terminal 400. In certain embodiments, the user terminal 400 can compare the meta data of each application with the associated keywords to calculate correlations between the associated keywords and each of the applications. The user terminal 400 can determine an application to be recommended corresponding to the received keyword, based on the correlations.

Then, in operation S1210, the user terminal 400 displays the recommended applications on a screen thereof. In operation S1210, if a keyword is selected from an application that is running, the user terminal 400 can display a recommended application corresponding to the selected keyword on the screen. The user terminal 400 can display, for example, an icon of the recommended application corresponding to the selected keyword on the screen. Also, the user terminal 400 can display the recommended application corresponding to the selected keyword, for example, in the form of a popup window on the screen. Also, the user terminal 400 can display the recommended application corresponding to the selected keyword on the screen, for example, by using a hyperlink.

Also, in operation S1210, the user terminal 400 can display recommended applications in such a manner that recommended applications that are running or being downloaded may be differentiated from one another.

Then, in operation S1212, the user terminal 400 runs one of the recommended applications. In operation S1212, if one of the recommended applications is selected according to a user's input, the user terminal 400 can run the selected recommended application. If the selected recommended application has not been installed in the user terminal 400, the user terminal 400 can download the selected recommended application by using linked information corresponding to the selected recommended application.

In operation S1214, the user terminal 400 can input a selected keyword into the recommended application to display the recommended application when the recommended application is running. In certain embodiments, the user terminal 400 can input a selected keyword into the recommended application to display the recommended application that is to be downloaded.

The present disclosure can be embodied as computer readable code in a computer readable medium. Here, the computer readable medium can be any recording apparatus capable of storing data that is read by a computer system, e.g., a read-only memory (ROM), a random access memory (RAM), a compact disc (CD)-ROM, a magnetic tape, a floppy disk, an optical data storage device, and so on. The computer readable medium can be distributed among computer systems that are interconnected through a network, and the present invention can be stored and implemented as computer readable code in the distributed system.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A user terminal for recommending an application by using a keyword, the user terminal comprising:
a keyword extraction unit configured to extract a keyword from an active application;
a recommended application determination unit configured to determine an application to recommend corresponding to the extracted keyword; and
a display unit configured to display the determined application.

2. The user terminal of claim 1, further comprising a keyword providing unit configured to provide the extracted keyword to a server, and
wherein the recommended application determination unit determines the application to recommend from a list of applications based on the extracted keyword, the list of applications being received from the server.

3. The user terminal of claim 2, wherein the list of applications are determined by the server based on correlations between the extracted keyword and applications.

4. The user terminal of claim 3, wherein the list of applications is determined by the server based on correlations between at least one of the extracted keyword and a plurality of keywords associated with the extracted keyword, and applications.

5. The user terminal of claim 3, wherein the correlations are determined by the server based on a category of the extracted keyword.

6. The user terminal of claim 3, wherein the correlations are determined by the server based on hyperlinked information corresponding to the extracted keyword.

7. The user terminal of claim 1, wherein the keyword extraction unit extracts the keyword that is input to the active application.

8. The user terminal of claim 1, wherein the keyword extraction unit extracts the keyword from a text contained in the active application.

9. The user terminal of claim 1, wherein, if the keyword is extracted from a text displayed in the active application, the display unit displays a list of recommended applications corresponding to the extracted keyword on a screen thereof.

10. The user terminal of claim 9, wherein, if a recommended application is selected from the list of recommended applications, the selected recommended application is executed.

11. The user terminal of claim 10, wherein, if the selected recommended application is executed, the selected keyword is input to the recommended application.

12. The user terminal of claim 1, further comprising a keyword providing unit configured to provide the extracted keyword to the server, and
wherein the recommended application determination unit determines the application to recommend based on a plurality of keywords associated with the provided keyword, the plurality of keywords being received from the server.

13. The user terminal of claim 12, wherein the recommended application determination unit determines the application to recommend based on correlations between the plurality of associated keywords and the active applications in the user terminal.

14. A server for recommending an application by using a keyword, the server comprising:
a keyword receiving unit configured to receive a keyword from a user terminal;
a recommended application determination unit configured to determine at least one application to be recommended based on the received keyword; and
an application recommending unit configured to provide a list of recommended applications to the user terminal;
wherein the received keyword is extracted from an application that is running in the user terminal.

15. The server of claim 14, wherein the recommended application determination unit determines the list of recommended applications based on correlations between the received keyword and the recommended applications.

16. The server of claim 15, wherein the recommended application determination unit determines the correlations based on hyperlinked information corresponding to the received keyword.

17. The server of claim 14, further comprising an associated keyword collection unit configured to collect keywords associated with the received keyword, and
wherein the recommended application determination unit determines the list of recommended application based on the collected associated keywords.

18. The server of claim 17, wherein the recommended application determination unit determines the list of recommended application based on the correlations between at least one of the received keyword and the collected associated keywords, and the recommended applications.

19. The server of claim 14, wherein at least one application in the list of recommended applications provided to the user terminal is installed to the user terminal.

20. The server of claim 14, wherein the received keyword is extracted from a text that is input to the application that is running in the user terminal.

21. The server of claim 14, wherein the received keyword is extracted from a text contained in the application that is running in the user terminal.

22. A server for providing associated keywords for recommending an application, the server comprising:
a keyword receiving unit configured to receive a keyword from a user terminal;
an associated keyword generation unit configured to collect keywords associated with the received keyword; and
an associated keyword providing unit configured to provide the collected associated keywords to the user terminal,
wherein the received keyword is extracted from an active application in the user terminal, and
the provided associated keywords are used by the user terminal to recommend an application.

23. The server of claim 22, wherein the provided associated keywords are used for the user terminal to determine correlations between the provided associated keywords and applications, and
the user terminal determines a recommended application based on the correlations.

24. A method of recommending an application by using a keyword, the method comprising:
extracting a keyword from an application that is running that is running in a user terminal;
determining an application to be recommended corresponding to the extracted keyword; and
displaying the recommended application to recommend.

25. The method of claim 24, further comprising providing the extracted keyword to a server, and
wherein the determining of the application to be recommended comprises determining the application to be recommended from a list of recommended applications based on the extracted keyword, the extracted keyword being received from the server.

26. The method of claim 25, wherein the list of recommended applications is determined by the server based on correlations between at least one of the provided keyword and a plurality keywords associated with the extracted keyword, and applications.

27. The method of claim 26, wherein the correlations are determined by the server based on a category of the provided keyword.

28. The method of claim 24, wherein, if a keyword displayed in the application is selected, the displaying of the recommended application comprises displaying a list of recommended applications corresponding to the selected keyword on a screen of the user terminal.

29. The method of claim 28, if an application included in the list of recommended applications is selected, further comprising running the selected recommended application.

30. The method of claim 29, further comprising inputting the selected keyword into the recommended application that is running.

31. The method of claim 24, further comprising providing the extracted keyword to the server, and
wherein the determining the application to be recommended comprises determining the application to be recommended based on keywords associated with the extracted keyword, the associated keyword being received from the server.

32. The method of claim 31, wherein the determining the application to be recommended comprises determining the application to recommend based on correlations between the associated keywords and applications in the user terminal.

33. A method of recommending an application to a user terminal by using a keyword, the method comprising:
receiving a keyword from the user terminal;
determining a list of applications to recommend based on the received keyword;
providing the list of applications to the user terminal,
wherein the received keyword is extracted from an application that is running in the user terminal.

34. A method of providing a user terminal with associated keywords for recommending an application, the method comprising;
receiving a keyword from the user terminal;
collecting a plurality of keywords associated with the received keyword; and
providing the plurality of collected keywords to the user terminal,
wherein the received keyword is extracted from an application that is running in the user terminal, and
the associated keywords are used for the user terminal to recommend an application.

35. A computer readable recording medium having recorded thereon a computer program for executing the method of claim 24.

36. A computer readable recording medium having recorded thereon a computer program for executing the method of claim 33.

37. A computer readable recording medium having recorded thereon a computer program for executing the method of claim 34.
